(19) United States
(12) Patent Application Publication
(10) Pub. No.: US 2026/0351039 A1
(43) Pub. Date: Nov. 5, 2026

(54) METHOD FOR PROCESSING A PROOF IMAGE, ASSOCIATED COMPUTER DEVICE AND COMPUTER PROGRAM

(71) Applicant: IDEMIA PUBLIC SECURITY FRANCE, Courbevoie (FR)

(72) Inventors: Guy MABYALAHT, Courbevoie (FR); Laurent KAZDAGHLI, Courbevoie (FR)

(73) Assignee: IDEMIA PUBLIC SECURITY FRANCE, Courbevoie (FR)

(21) Appl. No.: 19/487,010

(22) PCT Filed: May 15, 2024
(86) PCT No.: PCT/EP2024/063368

§ 371 Date: Nov. 24, 2025

(30) Foreign Application Priority Data
Jun. 30, 2023 (FR) FR2306958

(51) Int. Cl. G06V 40/12; G06V 10/26; G06V 10/34; G06V 10/44; G06V 10/82

(52) U.S. Cl. CPC G06V 40/1347; G06V 10/267; G06V 10/34; G06V 10/457; G06V 10/82; G06V 40/1365

(57) ABSTRACT

A method of processing a test image showing a plurality of latent prints, including generation by a neural network of a semantic segmentation map comprising, for each block of a plurality of blocks of the test image, a score indicative of a probability of existence of a latent fingerprint passing through the block, generating a binary map estimating, for each block of the plurality of blocks, whether or not the block shows a part of a latent fingerprint, detecting a plurality of instances of latent prints from the binary map, for each instance of the plurality of instances, obtaining an aggregate score by aggregating the scores associated with the blocks of the plurality of blocks that belong to said instance, and obtaining a restricted plurality of instances by restricting the plurality of instances to each instance whose aggregate score is above a threshold.

The invention relates to a method for processing a proof image showing a plurality of latent prints. The invention also relates to a computer device and an associated computer program.

Methods are known for identifying or authenticating an individual using their papillary prints, for example a fingerprint and/or a palm print and/or a footprint, these methods comprising the following steps. Conventionally, a test image showing a test fingerprint of an individual is acquired, and this image is compared with a reference image showing a reference fingerprint to verify a match between the test fingerprint and the reference fingerprint. If such a match is found, then the individual is considered to have been previously enrolled.

In a police investigation context, it is possible to use as a test image a photograph of one or more papillary marks left on a medium by the apposition of an area of skin presenting papillary ridges. This photograph is typically acquired by a generic device, i.e. a device not specifically designed for acquiring papillary prints.

A papillary trace appearing in an image of this type is commonly referred to as a “latent” fingerprint and can be likened to a papillary fingerprint.

Comparing a reference image showing a reference fingerprint with a test image showing several latent prints degrades the performance of identification and authentication processes, typically the false negative rate and/or the false positive rate.

To remedy this, it is known to manually dissociate the latent prints from the test image, i.e. to instantiate the latent prints from the test image, to allow them to be processed individually by the identification and authentication processes.

This separation is carried out manually by a specialist and is not very efficient for large quantities of test images.

The document “Automatic Latent Fingerprint Segmentation” by Dinh-Luan Nguyen, Kai Cao and Anil K. Jain, arXiv:1804.09650v2 describes the use of neural networks that perform instance segmentation of a fingerprint and the possibility of processing a test image showing a plurality of latent fingerprints to separate the latent fingerprints from said test image. However, instance segmentation neural networks are complex to implement and particularly costly in terms of computing time and memory space.

In addition, a test image may show several types of papillary prints, typically one or more latent fingerprints and one or more latent palm prints.

To overcome these disadvantages, the present invention proposes, in a first aspect, a method for processing a proof image showing a plurality of latent prints, the method comprising the following steps implemented by a computer device:
generation by a neural network of a semantic segmentation map from the test image, the semantic segmentation map comprising, for each block forming part of a plurality of blocks of the test image, a score associated with the block indicative of a probability of existence in the test image of a latent fingerprint passing through the block,
generating a binary map from the semantic segmentation map, the binary map estimating, for each block of the plurality of blocks of the evidence image, whether or not the block shows a portion of a latent fingerprint,
detecting a plurality of instances of latent prints from the binary map,
for each instance of the plurality of instances, obtaining an aggregate score from the semantic segmentation map, the aggregate score being obtained by aggregating the scores associated with the blocks of the plurality of blocks of the proof image that belong to said instance,
obtaining a restricted plurality of instances by restricting the plurality of instances to each instance whose aggregate score is greater than a predetermined threshold.

According to advantageous and non-limiting features:
the aggregate score of an instance is the average of the scores associated with the blocks of the plurality of blocks of the test image that show a portion of the latent fingerprint of said detected instance;
the step of detecting a plurality of latent fingerprint instances comprises a sub-step of applying watershed segmentation to the binary map using a sliding window;
the step of detecting a plurality of latent fingerprint instances comprises a sub-step of applying a connected component analysis to another binary map obtained from the binary map;
the step of detecting a plurality of latent fingerprint instances further comprises the following sub-step: obtaining the other binary map by eroding the binary map with an erosion window having a predetermined area, to eliminate blocks from the proof image that show a portion of a latent fingerprint having an area smaller than the predetermined area;
the method comprises, between the step of detecting a plurality of instances of latent prints and, for each instance of the plurality of instances, the step of obtaining an aggregate score, a step of reducing the plurality of instances;
the step of reducing the plurality of instances comprises the following sub-step: for each instance of the plurality of instances, defining a detection box, the detection box being the smallest rectangular box that completely contains said instance;
the step of reducing the plurality of instances comprises the following sub-step: deleting an instance from the plurality of instances if its detection box is included in a detection box of another instance from said plurality of instances;
The step of reducing the plurality of instances comprises the following sub-step: merging a first instance and a second instance from the plurality of instances if the intersection of a detection box of the first instance and a detection box of the second instance is greater than a predefined fraction of the union of said detection box of the first instance and detection box of the second instance;
the method further comprises an identification step in which at least one latent fingerprint instance from the restricted plurality of instances is individually compared to a reference fingerprint to verify a match between each latent fingerprint from the at least one latent fingerprint instance and the reference fingerprint.

According to a second aspect, the invention proposes a computer programme comprising code instructions for executing a method of processing a proof image as defined above, when these instructions are executed by the computer.

This programme may use any programming language and be in the form of source code, object code, or intermediate code between source code and object code, such as in a partially compiled form, or in any other desirable form.

According to a third aspect, the invention provides a computer-readable storage medium storing instructions executable by the computer for performing a proof image processing method as defined above.

A computer-readable storage medium is typically a tangible or non-transitory medium and may include a storage medium such as a hard disk drive, a magnetic tape device, or a semiconductor memory device and the like.

According to a fourth aspect, the invention provides a computer device for processing a proof image showing a plurality of latent prints, the computer device being configured to:
generate, using a neural network, a semantic segmentation map from the test image, the semantic segmentation map comprising, for each block forming part of a plurality of blocks of the test image, a score associated with the block indicative of a probability of existence in the test image of a latent fingerprint passing through the block,
generating a binary map from the semantic segmentation map, the binary map estimating, for each block of the plurality of blocks of the evidence image, whether or not the block shows a portion of a latent fingerprint,
detecting a plurality of instances of latent fingerprints from the binary map,
obtaining for each instance of the plurality of instances an aggregate score from the semantic segmentation map, the aggregate score being obtained by aggregating the scores associated with the blocks of the plurality of blocks of the test image that belong to said instance,
obtaining a restricted plurality of instances by restricting the plurality of instances to each instance whose aggregate score is greater than a predetermined threshold.

This computer device may be configured to implement each of the possible embodiments envisaged for the process of processing a proof image as defined above.

Of course, the various features, variants and embodiments of the invention may be combined with each other in various combinations, provided that they are not incompatible or mutually exclusive.

Other features and advantages of the present invention will become apparent from the description below, with reference to the accompanying figures, which illustrate examples of embodiments that are not intended to be limiting.

In the figures:

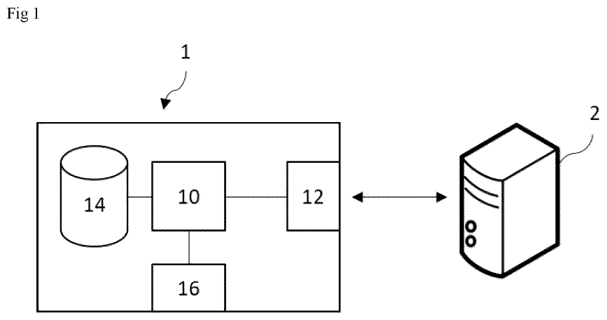

FIG. 1 schematically represents a preferred embodiment of a computer device and a server for implementing a method according to the invention;

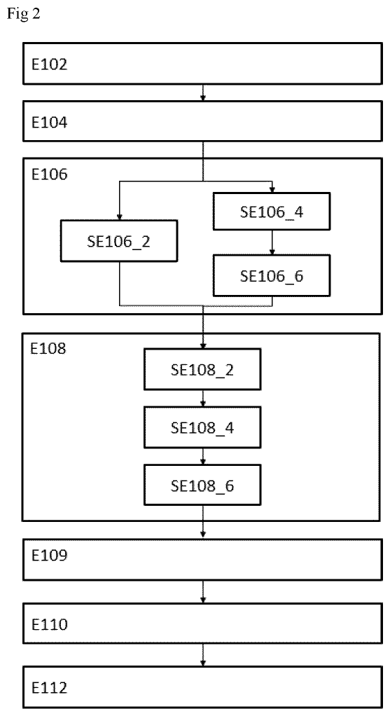

FIG. 2 illustrates the steps of an embodiment of a method for processing a proof image showing a plurality of latent prints, according to the invention.

FIG. 1 schematically represents a preferred embodiment of a computer device 1 for processing a proof image, and a server 2, for implementing a method according to the invention.

The computer device 1 for processing a proof image comprises a processor 10, a communication interface 12 and a memory 14. The computer device 1 may also comprise an image sensor 16 for displaying fingerprints.

The computer device 1 may be a device such as a microcomputer, a workstation or a lightweight portable device.

The processor 10 is configured to implement the steps of a proof image processing method that will be described below. The processor 10 may have any structure. The processor comprises one or more cores, each core being configured to execute instructions of a computer programme so as to implement the aforementioned steps. It will be seen below that this programme uses a semantic segmentation neural network.

The communication interface 12 is adapted to enable the computer device 1 for processing a proof image to receive proof images to be processed and to communicate with a server 2. The communication interface 12 is of any type. For example, it may be wired (Ethernet) or wireless using any communication protocol (Wi-Fi, Bluetooth, etc.).

The memory 14 is adapted to store data manipulated or produced by the processor 10. The memory 14 may be of any type. Conventionally, memory 14 comprises volatile memory for storing data temporarily, and non-volatile memory for storing data persistently, i.e. in a manner that retains the data when the non-volatile memory is powered down.

Memory 14 is particularly suited to storing a proof image received by computing device 1 and intended to be processed by processor 10.

In addition, memory 14 stores computer program instructions, some of which are designed to implement a method of processing a proof image according to the invention, typically as described with reference to FIG. 2, when these instructions are executed by processor 10.

The image sensor 16 may optionally comprise a transparent surface serving as a support for a finger or palm, for example, so as to stabilise the finger or palm and thus clearly show a fingerprint of the finger or a palm image of the palm in an image provided by the sensor.

The image sensor 16 allows a reference papillary print to be acquired.

The server 2 stores a database comprising reference images showing reference papillary prints relating to previously enrolled reference individuals.

In this embodiment, the computer device 1 is separate from the server.

2, as shown in FIG. 1. However, in another embodiment, it is possible that the computer device 1 constitutes the server 2.

In the following description, a “fingerprint” refers to a papillary fingerprint, a “latent fingerprint” refers to a latent papillary fingerprint, and a “reference fingerprint” refers to a reference papillary fingerprint.

A reference fingerprint is understood here to be a fingerprint intended to be acquired in a controlled and voluntary manner using a biometric acquisition means, for example the image sensor 16.

FIG. 2 illustrates the steps of an embodiment of a method for processing a proof image showing a plurality of latent prints, according to the invention.

This method is implemented by the computer device 1.

The term “proof image” here refers to a photograph of one or more papillary marks left on a medium by the apposition of an area of skin with papillary ridges, i.e. a photograph of one or more latent fingerprints.

According to a step (step E102) of generating a semantic segmentation map, the computer device 1 generates, by means of a neural network, a semantic segmentation map from a test image.

The test image is typically stored in the memory 14 of the computer device 1, for example following its reception (step not shown) by the computer device 1 via the communication interface 12.

Various semantic segmentation neural networks are known to those skilled in the art. As a non-limiting example, semantic segmentation can be implemented by a convolutional neural network as described in the doctoral thesis from the University of Lyon entitled “Convolutional neural networks for semantic segmentation and colour invariant learning”, Damien Fourure, publicly defended on Dec. 12, 2017.

A semantic segmentation map comprises, for each block forming part of a plurality of blocks of the test image, a score associated with the block indicative of a probability of existence in the test image of a latent fingerprint passing through the block.

Typically, for each block forming part of a plurality of blocks of the test image, the score is a real number between 0 and 1, i.e. 0 and 1 inclusive, with the score associated with a block tending towards 1 if a latent fingerprint passes through the block associated with the score, and towards 0 if no latent fingerprint passes through the block associated with the score.

In this text, a “block” of an image constitutes a contiguous region of the image comprising one or more pixels of the image. In a preferred embodiment, each block considered is in fact a pixel of the test image. In this case, if the plurality of blocks of the test image is the set of blocks covering the entire test image, the plurality of blocks of the test image is the set of pixels of the test image.

The method then comprises a step (step E104) of generating a binary map, during which the computing device 1 generates a binary map from the semantic segmentation map.

The binary map estimates, for each block of the plurality of blocks of the proof image, whether or not the block shows a portion of a latent fingerprint.

The binary map comprises, for each block forming part of the plurality of blocks of the test image, a binary indicator associated with said block.

Typically, during this step (step E104) of generating a binary map, the computer device 1 binarises the semantic segmentation map obtained in the step (step E102) of generating a semantic segmentation map, using a predefined threshold.

For example, if each score is a real number between 0 and 1 as described above, the threshold may have a value of 0.5.

In this case, the binary indicator associated with a block may have a value of:
0 when the score associated with said block in the semantic segmentation map has a value lower than the threshold;
1 when the score associated with said block in the semantic segmentation map has a value greater than the threshold.

A binary indicator of 0 indicates that the associated block does not show a latent fingerprint portion, while a binary indicator of 1 indicates that the associated block shows a latent fingerprint portion.

The method then comprises a step (step E106) of detecting a plurality of instances of latent fingerprints from the binary map.

During this step (step E106), the computer device 1 divides latent fingerprints from the proof image into individual instances.

The step of detecting a plurality of instances of latent fingerprints from the binary map consists of segmenting latent fingerprints from the binary map by instance.

Advantageously, the step (step E106) of detecting a plurality of latent fingerprint instances from the binary map comprises a sub-step (sub-step SE106_2) of applying watershed segmentation to the binary map by means of a sliding window. watershed segmentation”) to the binary map by means of a sliding window.

The method thus makes it possible to better separate latent fingerprints that touch each other.

The sliding window typically has an area of u×u blocks, where u has a value determined as follows:

$$u = 256 xr \frac{where r}{500} is$$

the image resolution in blocks per inch.

For example, the sliding window has an area of 256×256 pixels for a proof image with a resolution of 500 pixels per inch (abbreviated as dpi), with one block being one pixel in this example.

In another example, the sliding window has an area of 512×512 pixels for a proof image with a resolution of 1000 dpi.

Segmentation by watershed thus focuses on the detection of small latent prints, typically latent fingerprints. In addition, this window size speeds up calculations on proof images while avoiding oversegmentation of latent fingerprints.

Various watershed segmentation algorithms are known to those skilled in the art. As a non-limiting example, the method may implement watershed segmentation as described in the document “Watershed Segmentation Algorithm Based on Morphological Gradient Reconstruction,” Baoan Han, 2015 2nd International Conference on Information Science and Control Engineering.

Watershed segmentation uses the binary map in geographical terms. This segmentation considers the binary map as a topographical relief, where the distance of a block showing a part of a latent fingerprint from the nearest blocks not showing a part of a latent fingerprint represents an altitude of said block showing a part of a latent fingerprint. A block that does not show a latent fingerprint has an altitude of zero. Next, watershed segmentation searches for the watersheds of said relief and separates the different areas of the binary map. Each area obtained from the binary map corresponds to a watershed.

Similarly, the step (step E106) of detecting a plurality instances of latent fingerprints from the binary map comprises two other sub-steps. In this case, the step (step E106) of detecting a plurality of instances of latent fingerprints from the binary map comprises a sub-step (sub-step SE106_4) of obtaining another binary map and then a sub-step (sub-step SE106_6) of applying a connected component analysis to the other binary map.

During the sub-step (sub-step SE106_4) of obtaining another binary map, the computer device 1 obtains the other binary map from the binary map.

According to a first example, the other binary map is the binary map.

According to a second example, the other binary map is obtained by eroding the binary map with an erosion window having a predetermined area, to remove blocks of the proof image that show a part of the latent print having an area smaller than the predetermined area.

The predetermined area of the erosion window is typically u×u blocks, where u has a value determined as follows:

$$u = \frac{200 xr}{500}$$

where r^{is} the resolution of the test image in blocks per inch.

The predetermined area of the erosion window is, for example, 200×200 pixels for a proof image with a resolution of 500 dpi, a block being a pixel in this example.

In another example, the erosion window has an area of 400×400 pixels for a proof image with a resolution of 1000 dpi.

An area is said to be smaller than another area, said other area being delimited by a window, if the area can be contained within said other area, i.e. if the area can be contained within said window delimiting the other area.

Erosion of the binary map allows the analysis by connected components to focus on the detection of large latent prints, typically latent palm prints.

Next, during the sub-step (sub-step SE106_6) of applying a connected component analysis to the other binary map, the computer device 1 applies a connected component analysis to the other binary map.

Related component analysis allows for better segmentation of latent palm prints than watershed segmentation.

Various connected component analysis algorithms are known to those skilled in the art. As a non-limiting example, the method may implement connected component analysis as described in “The connected-component labelling problem: A review of state-of-the-art algorithms”, Lifeng He et al., Elsevier: Pattern Recognition Volume 70 (2017) pages 25-43.

Connected component analysis connects, for a given block showing part of a latent fingerprint, all neighbouring blocks to said given block that show part of a latent fingerprint. Connected component analysis thus groups together blocks showing part of a latent fingerprint that are connected, i.e. that are adjacent.

In the embodiment shown in FIG. 2, the step (step E106) of detecting a plurality of instances of latent fingerprints from the binary map comprises the sub-step (sub-step SE106_2) of applying watershed segmentation, the sub-step (sub-step SE106_4) of obtaining another binary map, and the sub-step (sub-step SE106_6) of applying a connected component analysis to the other binary map.

The method allows one or more latent fingerprints and/or palm prints to be detected simultaneously and efficiently.

The sub-step (sub-step SE106_2) of applying a watershed segmentation watershed line segmentation may be implemented in parallel with the sub-steps of obtaining another binary map (sub-step SE106_4) and applying a connected component analysis to the other binary map (sub-step SE106_6), for example:
by means of a processor comprising several cores, at least one core being configured to execute the sub-step (sub-step SE106_2) of applying a watershed segmentation and at least one other core being configured to execute the sub-steps of obtaining another binary map (sub-step SE106_4) and applying a connected component analysis to the other binary map (sub-step SE106_6), and/or
by means of several processors, at least one processor being configured to execute the sub-step (sub-step SE106_2) of applying a watershed segmentation and at least one other processor being configured to execute the sub-steps of obtaining another binary map (sub-step SE106_4) and applying a connected component analysis to the other binary map (sub-step SE106_6).

According to another possibility, the sub-step (sub-step SE106_2) of applying a watershed segmentation, the sub-step of obtaining another binary map (sub-step SE106_4) and the sub-step of applying a connected component analysis to the other binary map (sub-step SE106_6) may be implemented sequentially by the computer device 1.

In a first alternative embodiment, it may be envisaged that the step (step E106) of detecting a plurality of instances of latent fingerprints from the binary map comprises the sub-step (sub-step SE106_2) of applying watershed segmentation but does not comprise a sub-step (sub-step SE106_4) of obtaining another binary map or a sub-step (sub-step SE106_6) of applying a connected component analysis to the other binary map.

In a second embodiment, it may be envisaged that the step (step E106) of detecting a plurality of instances of latent fingerprints from the binary map comprises the sub-step (sub-step SE106_4) of obtaining another binary map and the sub-step (sub-step SE106_6) of applying a connected component analysis to the other binary map, but does not include a sub-step (sub-step SE106_2) of applying watershed segmentation.

The method continues with a step (step E108) of reducing the plurality of instances, i.e., reducing the plurality of instances detected during the detection step (step E106).

The step (step E108) of reducing the plurality of instances comprises a sub-step (sub-step SE108_2) of defining detection boxes.

During this sub-step (sub-step SE108_2) of defining detection boxes, the computer device 1 defines, for each instance of the plurality of instances, a detection box, the detection box being the smallest rectangular box that entirely contains said instance.

Advantageously, the step (step E108) of reducing the plurality of instances may then comprise a sub-step (sub-step SE108_4) of deleting at least one instance from the plurality of instances, during which the computing device 1 deletes one instance from the plurality of instances, i.e. an instance from the plurality of instances detected during the detection step (step E106), if its detection box is included in a detection box of another instance from said plurality of instances.

Advantageously, the step (step E108) of reducing the plurality of instances may include a sub-step (sub-step SE108_6) of merging after the sub-step (sub-step SE108_4) of deleting at least one instance from the plurality of instances.

During this sub-step (sub-step SE108_6) of merging, the computing device 1 merges a first instance and a second instance of the plurality of instances if the intersection of a detection box of the first instance and a detection box of the second instance is greater than a predefined fraction of the union of said detection box of the first instance and detection box of the second instance.

The merging of a first instance and a second instance results in a single instance, the reduced plurality of instances comprising the single instance but not comprising the first instance or the second instance.

The predefined fraction is typically 0.6.

In the embodiment shown in FIG. 2, the step (step E108) of reducing the plurality of instances comprises the sub-step (sub-step SE108_2) of defining detection boxes, the sub-step (sub-step SE108_4) of deleting detection boxes, and the sub-step (sub-step SE108_6) of merging.

In a first alternative embodiment, it may be envisaged that the step (step E108) of reducing the plurality of instances comprises the sub-step (sub-step SE108_2) of defining detection boxes and the sub-step (sub-step SE108_4) of deleting detection boxes, but does not include the sub-step (sub-step SE108_6) of merging.

In a second embodiment, it may be envisaged that the step (step E108) of reducing the plurality of instances comprises the sub-step (sub-step SE108_2) of defining detection boxes and the sub-step (sub-step SE108_6) of merging, but does not include the sub-step (sub-step SE108_4) of deleting detection boxes. This second other embodiment may be advantageous when the step (step E106) of detecting a plurality of latent fingerprint instances from the binary map is according to the first other embodiment described above for said detection step (step E106).

A, following the step (step E108) of reducing the plurality of instances, the plurality of instances comprises a number of instances less than or equal to the number of instances detected during the detection step (step E106).

The step of reducing the plurality of instances makes it possible to limit oversegmentation and improve the efficiency of the process by limiting the calculations required for the subsequent steps.

The process continues with a step (step E109) of obtaining aggregate scores, during which the computer device 1 obtains for each instance of the plurality of instances, i.e. in this case for each instance of the plurality of instances reduced by the reduction step (step E108), an aggregate score from the semantic segmentation map.

During this step (step E109) of obtaining aggregate scores, the computer device 1 obtains, for each instance of the plurality of instances, an aggregate score by aggregating the scores associated with the blocks of the plurality of blocks of the test image that belong to said instance.

Typically, the aggregate score of an instance is the average of the scores associated with the blocks of the plurality of blocks of the test image that show a portion of the latent fingerprint of said instance.

The process continues with a step (step E110) of obtaining a restricted plurality of instances, during which the computer device 1 obtains the restricted plurality of instances by restricting the plurality of instances to each instance whose aggregate score is greater than another predetermined threshold.

The aggregate scores thus make it possible to better filter out false detections of latent fingerprint instances.

When the scores are real numbers between 0 and 1 and the aggregate score of an instance is the average of the scores associated with the blocks of the plurality of blocks of the test image that show a part of the latent fingerprint of said instance, the other predetermined threshold preferably has a value between 0.6 and 0.75, i.e. 0.6 and 0.75 inclusive, for example 0.6.

The restricted plurality of instances comprises all, and only, the instances of the plurality of instances whose aggregate score is greater than the other predetermined threshold, i.e. here the instances of the plurality of instances reduced by the reduction step (step E108) whose aggregate score is greater than the other predetermined threshold.

The method enables rapid and efficient detection, typically segmentation by instance, of a plurality of latent fingerprints.

This process uses a semantic segmentation neural network followed by post-processing, and does not require an instance segmentation neural network.

The process may further continue with an identification step (step E112) during which the computing device 1 individually compares at least one latent fingerprint instance from the restricted plurality of instances to a reference fingerprint, to verify a match between each latent fingerprint of the at least one latent fingerprint instance and said one reference fingerprint.

A person skilled in the art will understand that steps in this process may be omitted to the extent that the other steps have the elements (e.g., a plurality of instances) necessary for their execution.

For example, the step (step E108) of reducing the plurality of instances may be omitted.

In this case, during the step (step E109) of obtaining aggregate scores, the computer device 1 obtains for each instance of the plurality of instances, i.e. here for each instance of the plurality of instances detected during the detection step (step E106), an aggregate score from the semantic segmentation map.

Furthermore, the restricted plurality of instances obtained during the step (step E110) of obtaining a restricted plurality of instances comprises all, and only, the instances of the plurality of instances whose aggregate score is greater than the other predetermined threshold, i.e. here the instances of the plurality of instances detected during the detection step (step E106) whose aggregate score is greater than the other predetermined threshold.

A person skilled in the art will also understand that steps and/or sub-steps of the process may be performed in other orders, provided that each step and/or sub-step has the elements (e.g. the binary map) necessary for its execution.

According to a first example, when the step (step E106) of detecting a plurality of instances of latent fingerprints from the binary map comprises the sequential implementation of the sub-step (sub-step SE106_2) of applying a watershed segmentation, the sub-step (sub-step SE106_4) of obtaining another binary map, and the sub-step (sub-step SE106_6) of applying a connected component analysis to the other binary map:
Sub-step (sub-step SE106_2) of applying a watershed segmentation may be performed before the sub-step (sub-step SE106_4) of obtaining another binary map and the sub-step (sub-step SE106_6) of applying a connected component analysis to the other binary map, or
the sub-step (sub-step SE106_2) of applying a watershed segmentation may be performed after the sub-step (sub-step SE106_4) of obtaining another binary map and after the sub-step (sub-step SE106_6) of applying a connected component analysis to the other binary map, or
sub-step (sub-step SE106_2) of applying a watershed segmentation may be performed after the sub-step (sub-step SE106_4) of obtaining another binary map and before the sub-step (sub-step SE106_6) of applying a connected component analysis to the other binary map.

According to a second example, the step (step E109) of obtaining aggregate scores may be performed before the step (step E108) of reducing the plurality of instances.

In this case, if the step (step E108) of reducing the plurality of instances includes the sub-step (sub-step SE108_6) of merging, when the computing device 1 merges a first instance and a second instance of the plurality of instances, the computing device merges the aggregate score of the first instance with the aggregate score of the second instance.

Typically, the computing device may associate with the instance resulting from the merging of a first instance and a second instance, the aggregate score of the instance resulting from the merging having the highest value among the aggregate score of the first instance and the aggregate score of the second instance, or an average, possibly weighted, of the aggregate score of the first instance and the aggregate score of the second instance. The weighting may be a function of the number of blocks in the first instance showing a latent fingerprint portion and the number of blocks in the second instance showing a latent fingerprint portion (the number of blocks in an instance showing a latent fingerprint portion being determinable from the binary map associated with said instance).

1. A method for processing a proof image showing a plurality of latent prints, the method comprising the following steps implemented by a computer device:
generation by a neural network of a semantic segmentation map from the test image, the semantic segmentation map comprising, for each block forming part of a plurality of blocks of the test image, a score associated with the block indicative of a probability of existence in the test image of a latent fingerprint passing through the block,
generating a binary map from the semantic segmentation map, the binary map estimating, for each block of the plurality of blocks of the test image, whether or not the block shows a portion of a latent fingerprint,
detecting a plurality of instances of latent prints from the binary map,
for each instance of the plurality of instances, obtaining an aggregate score from the semantic segmentation map, the aggregate score being obtained by aggregating the scores associated with the blocks of the plurality of blocks of the test image that belong to said instance,
obtaining a restricted plurality of instances by restricting the plurality of instances to each instance whose aggregate score is greater than a predetermined threshold.

2. A method of processing a proof image according to claim 1, wherein the aggregate score of an instance is the average of the scores associated with the blocks of the plurality of blocks of the proof image that show a portion of the latent fingerprint of said detected instance.

3. A method for processing a proof image according to claim 1, wherein the step of detecting a plurality of instances of latent fingerprints includes a sub-step of applying watershed segmentation to the binary map by means of a sliding window.

4. A method for processing a proof image according to claim 1, wherein the step of detecting a plurality of instances of latent prints comprises a sub-step of applying a component analysis related components analysis to another binary map obtained from the binary map.

5. A method of processing a proof image according to claim 4, wherein the step of detecting a plurality of instances of latent prints further comprises the following sub-step:
obtaining the other binary map by eroding the binary map with an erosion window having a predetermined area, to remove blocks of the proof image that show a latent fingerprint portion having an area smaller than the predetermined area.

6. A method of processing a proof image according to claim 1, the method comprising, between the step of detecting a plurality of instances of latent prints and the step of obtaining an aggregate score for each instance of the plurality of instances, a step of reducing the plurality of instances comprising the following sub-steps:
for each instance of the plurality of instances, defining a detection box, the detection box being the smallest rectangular box that entirely contains said instance,
deleting an instance from the plurality of instances if its detection box is included in a detection box of another instance from said plurality of instances,
merging a first instance and a second instance of the plurality of instances if the intersection of a detection box of the first instance and a detection box of the second instance is greater than a predefined fraction of the union of said detection box of the first instance and detection box of the second instance.

7. A method of processing a proof image according to claim 1, the method further comprising an identification step in which at least one latent fingerprint instance of the restricted plurality of instances is individually compared with a reference fingerprint to verify a match between each latent fingerprint of the at least one latent fingerprint instance and the reference fingerprint.

8-9. (canceled)

10. A computer device for processing a proof image showing a plurality of latent prints, the computer device being configured to:
generating, by means of a neural network, a semantic segmentation map from the evidence image, the semantic segmentation map comprising, for each block forming part of a plurality of blocks of the evidence image, a score associated with the block indicative of a probability of existence in the evidence image of a latent fingerprint passing through the block,
generating a binary map from the semantic segmentation map, the binary map estimating, for each block of the plurality of blocks of the test image, whether or not the block shows a part of a latent fingerprint,
detect a plurality of instances of latent fingerprints from the binary map,
obtaining for each instance of the plurality of instances an aggregate score from the semantic segmentation map, the aggregate score being obtained by aggregating the scores associated with the blocks of the plurality of blocks of the test image that belong to said instance,
obtaining a restricted plurality of instances by restricting the plurality of instances to each instance whose aggregate score is greater than a predetermined threshold.

11. The computer device for processing a proof image according to claim 10, wherein the aggregate score of an instance is the average of the scores associated with the blocks of the plurality of blocks of the proof image that show a portion of the latent fingerprint of said detected instance.

12. The computer device for processing a proof image according to claim 10, wherein the computer device is configured to detect a plurality of instances of latent fingerprints includes a sub-step of applying watershed segmentation to the binary map by means of a sliding window.

13. The computer device for processing a proof image according to claim 10, wherein the computer device is configured to detect a plurality of instances of latent prints by applying a component analysis related components analysis to another binary map obtained from the binary map.

14. The computer device for processing a proof image according to claim 10, wherein the computer device is configured to detect a plurality of instances of latent prints by:
obtaining the other binary map by eroding the binary map with an erosion window having a predetermined area, to remove blocks of the proof image that show a latent fingerprint portion having an area smaller than the predetermined area.

15. The computer device for processing a proof image according to claim 10, wherein the computer device is configured to, between detecting a plurality of instances of latent prints and obtaining an aggregate score for each instance of the plurality of instances, reduce the plurality of instances by performing:
for each instance of the plurality of instances, defining a detection box, the detection box being the smallest rectangular box that entirely contains said instance,
deleting an instance from the plurality of instances if its detection box is included in a detection box of another instance from said plurality of instances, and
merging a first instance and a second instance of the plurality of instances if the intersection of a detection box of the first instance and a detection box of the second instance is greater than a predefined fraction of the union of said detection box of the first instance and detection box of the second instance.

16. The computer device for processing a proof image according to claim 10, wherein the computer device is configured to, in which at least one latent fingerprint instance of the restricted plurality of instances is individually compared with a reference fingerprint, verify a match between each latent fingerprint of the at least one latent fingerprint instance and the reference fingerprint.

17. A non-transitory computer-readable storage medium storing instructions that when executed cause a computer to perform a method for processing a proof image showing a plurality of latent prints, the method comprising:
generation by a neural network of a semantic segmentation map from the test image, the semantic segmentation map comprising, for each block forming part of a plurality of blocks of the test image, a score associated with the block indicative of a probability of existence in the test image of a latent fingerprint passing through the block,
generating a binary map from the semantic segmentation map, the binary map estimating, for each block of the plurality of blocks of the test image, whether or not the block shows a portion of a latent fingerprint,
detecting a plurality of instances of latent prints from the binary map,
for each instance of the plurality of instances, obtaining an aggregate score from the semantic segmentation map, the aggregate score being obtained by aggregating the scores associated with the blocks of the plurality of blocks of the test image that belong to said instance,
obtaining a restricted plurality of instances by restricting the plurality of instances to each instance whose aggregate score is greater than a predetermined threshold.

18. The non-transitory computer-readable storage medium according to claim 17, wherein the aggregate score of an instance is the average of the scores associated with the blocks of the plurality of blocks of the proof image that show a portion of the latent fingerprint of said detected instance.

19. The non-transitory computer-readable storage medium according to claim 17, wherein the step of detecting a plurality of instances of latent fingerprints includes a sub-step of applying watershed segmentation to the binary map by means of a sliding window.

20. The non-transitory computer-readable storage medium according to claim 17, wherein the step of detecting a plurality of instances of latent prints comprises a sub-step of applying a component analysis related components analysis to another binary map obtained from the binary map.

21. The non-transitory computer-readable storage medium according to claim 17, wherein the step of detecting a plurality of instances of latent prints further comprises the following sub-step:
obtaining the other binary map by eroding the binary map with an erosion window having a predetermined area, to remove blocks of the proof image that show a latent fingerprint portion having an area smaller than the predetermined area.

22. The non-transitory computer-readable storage medium according to claim 17, the method comprising, between the step of detecting a plurality of instances of latent prints and the step of obtaining an aggregate score for each instance of the plurality of instances, a step of reducing the plurality of instances comprising the following sub-steps:
for each instance of the plurality of instances, defining a detection box, the detection box being the smallest rectangular box that entirely contains said instance,
deleting an instance from the plurality of instances if its detection box is included in a detection box of another instance from said plurality of instances,
merging a first instance and a second instance of the plurality of instances if the intersection of a detection box of the first instance and a detection box of the second instance is greater than a predefined fraction of the union of said detection box of the first instance and detection box of the second instance.
